(19) United States
(12) Patent Application Publication
(10) Pub. No.: US 2019/0060777 A1
(43) Pub. Date: Feb. 28, 2019

(54) LIGHTING DEVICE FOR USE WITH COIL AND/OR SPRING TYPE AMUSEMENT PRODUCTS

(71) Applicant: LIGHTUPTOYS.COM LLC, Sellersburg, IN (US)

(72) Inventors: Joshua C. Kelly, Sellersburg, IN (US); Max Armendariz Lalama, Georgetown, IN (US); Macaulay Bruton, Jeffersonville, IN (US)

(21) Appl. No.: 16/117,329

(22) Filed: Aug. 30, 2018

Related U.S. Application Data
(60) Provisional application No. 62/552,431, filed on Aug. 31, 2017.

(51) Int. Cl. A63H 33/22; F21V 33/00; F21V 23/00; F21V 31/00; A63H 33/26

(52) U.S. Cl. CPC A63H 33/22; F21V 33/008; F21Y 2115/10; F21V 31/005; A63H 33/26; F21V 23/003

(57) ABSTRACT

The present device is directed toward an improved lighting device for use with a plastic coil spring amusement device and more particularly, toward an improved lighting device for use with a coil spring toy with an electronic sequenced multi-color lighting which reflects off the coils and/or springs to create new and exciting lighting effects. Further, the plastic coil springs of the device may include lighting within the plastic coils thereof.

### CROSS REFERENCE TO RELATED APPLICATION

This Application claims priority from provisional application Ser. No. 62/552,431, filed Aug. 31, 2017.

### BACKGROUND OF INVENTION

### 1. Field of Invention

The present invention is directed toward an improved lighting device for use with a coil spring amusement device, and more particularly, toward an improved lighting device for use with a coil spring toy with an electronic sequenced multi-color lighting which reflects off, or is included in, the coils and or springs to create new and exciting lighting effects.

### 2. Description of Related Art

A simple basic coil spring toy, which may be made from metal, plastic, plush, or other materials in whole or in part in any combination, which can be compressed and stretched, is usually in the form of a hand-held toy to play with an end in each hand. For example, a wave-like motion is created by up and down movements of both hands in opposite motion. Other play patterns are possible and the present invention can also be used as a wearable item.

Several variations of a basic lighting amusement device have been created including, for example, U.S. Pat. No. 6,000,991 to Truchsess et al., which discloses an attachment that generates light or sound, U.S. Pat. No. 5,431,591 to Muzzi, which discloses a sound device, and, U.S. Pat. No. 6,482,071 B1, which discloses lights placed on coils.

The present invention improves in a number of ways including a new improved lighting source which is exciting and substantially adds play value and a wearability design. The present invention is easily adopted for character-type products that will incorporate the coil or spring, such as, for example, a dog as depicted in the figures.

### BRIEF SUMMARY OF THE INVENTION

The present invention includes a lighting device for use with coil and/or spring type amusement products including a clear or opaque plastic container; lighting elements for use in the interior of the said container; a control unit; and a coil and/or spring having a plurality of connected rings defining an interior, a right end, and a left end, which coils may also include lighting elements.

The invention may include the use of LED or other lights or lighting within the container or the interior of the coils, wherein the container is a cylinder. The LEDs or other lights within the container and/or the coils may be arranged with varying lighting sequences and colors. LEDs within the preferably plastic coils interact with the LEDs within the container to enhance the visual impact of the device. The plastic material, which forms the coils, is chosen to enhance the visual impact of the enclosed LED lights.

The control unit includes at least one power source; circuitry; and at least one switch; and further includes at least one transmitter and/or receiver; and further light sequencing hardware and/or software. The associated product or device can be worn as a toy.

Additionally the device may include an attaching section or device or removably or non-removably attaching directly to an object, person, or surface directly or attached to a necklace, chain, pin, bracelet, or other wearable jewelry or another object, thing, or accessory.

Further included may be protrusions, limbs, arms, and/or other body parts, and/or other objects that come out from center and may be adjustable or movable either self-moving, self-adjusting or user adjusting or moving and/or may be itself shaped or styled as at least one of the following in part or in whole: animal, alien, monster, character, animated character, robot, food, super hero, person, place, thing, plant, rock, person's likeness or image, vehicle, boat, ship, car, motorcycle, rocket, jet, plane, truck, toy, consumer product, image, copy of photograph, copy of a painting, illustration, or drawing, bicycle, sports equipment, book, magazine, ball, logo, mascot, comic book character, place, or thing, planet, solar system, outer space, moon, satellite, comet, utensil, appliance, tool.

Further, the control unit and/or the coils may include LED lights which can be processed to have LED flashing patterns to create messages, words, slogans, patterns, animation, characters, numbers; whereby LED flashing patterns to create messages, words, slogans, patterns, animation, characters, numbers.

Further, certain parts may be removably attached and removed and exchanged for other corresponding parts that are themed or styled differently so you build your own or create your own unique embodiment.

Further, the device may include at least one microprocessor and/or electronic controller housed within at least one waterproof or water-resistant compartment and/or imbedded and/or hermetically sealed within at least one portion of said device.

Further, the device may include at least one of the following: GPS circuitry, at least one communication receiver device and/or the at least one communication transmitter device and/or the at least one communication transmitter/receiver device employing at least one of Wi-Fi, radio wave and/or electromagnetic radiation, Bluetooth communication capability.

Further, the device may include at least one lens capable of projecting at least one image on at least one external surface and/or at least one object and/or said at least one first layer and/or at least one interior surface of said device.

Further, the device may include at least one LED and/or source of light and at least one lens capable of projecting at least one image radially outward from and/or beneath it further utilizing edge lit technology and remote source light activation.

Further, the device may be secured to both ends of a spring and/or coil; wherein animated images are produced from layers of plastic capable of transmitting and radiating light; wherein each said layer of plastic is attached to a switch and wherein said plastic further utilizes edge lit technology and remote source light activation. The plastic coils have flexibility and resistance to wear and overuse. The plastic coils are made of plastic that is durable and able to transmit the visual impact of lighting present within those coils.

Further, the device can be used as at least one of the following: a neckless; a neckless drop; headwear, headband; bubble wand; toy sword; toy wand; nightlight; hat; jewelry attachment; toy cane; wherein animated images are removably attached and the animated images being viewed can change based on removing one animated image and inserting a different one and repeating this procedure as many times as required or desired.

### BRIEF DESCRIPTION OF DRAWINGS

The following description of at least one current embodiment of the figures and the figures filed herewith have been presented for the purposes of illustration and description. Other embodiments may become apparent to those skilled in the art from the below description, as well as, the specification, and claims herein, which show and/or describe illustrative embodiments of the present invention. As will be realized, the present invention can include other modifications in order to facilitate the desired results of the present invention, all without departing from the spirit and scope of the present invention. Accordingly, the description is to be regarded as illustrative in nature and not restrictive. Although not explicitly recited, one or more embodiments of the present invention may be practiced in combination or conjunction with one another.

FIG. 1 depicts a plastic cylinder having been placed inside plastic coils, the bottom of the cylinder attached to a control unit housing and all the required electronic components and circuitry. The plastic cylinder houses the lights, which in this embodiment are LED lights.

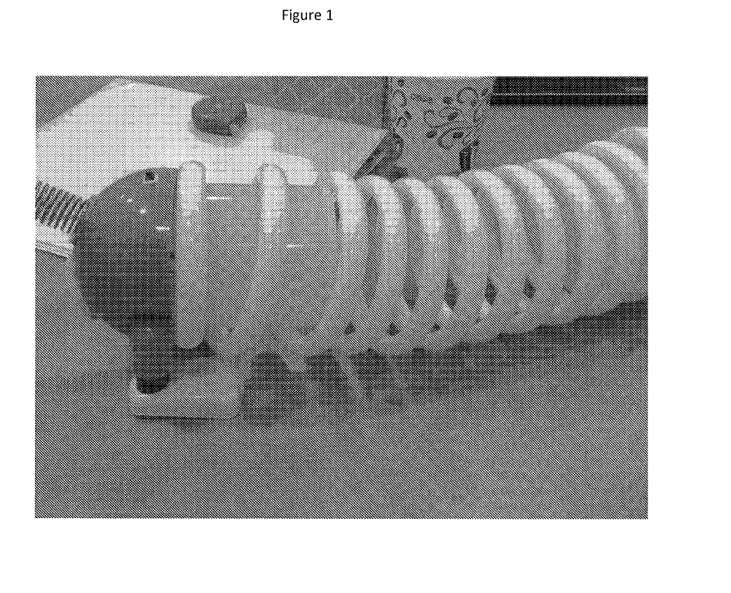

FIG. 2 depicts the plastic cylinder having been placed inside coils, with the LED lights on demonstrating the edge lit technology lighting effect and the light reflecting off the coils to light up the coils, the bottom of the cylinder attached to a control unit housing all the required electronic components and circuitry.

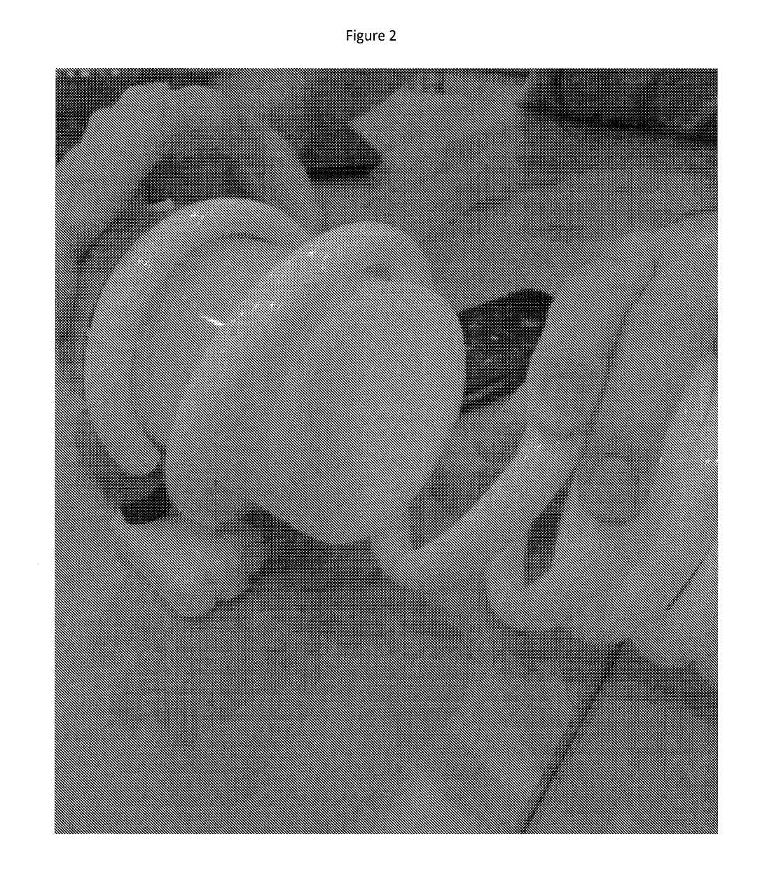

FIG. 3 depicts a second angle photograph of the plastic cylinder having been placed inside coils, with the LED lights on demonstrating the edge lit technology lighting effect and the light reflecting off the coils to light up the coils. The bottom of the cylinder is attached to a control unit and houses all the required electronic components and circuitry. The plastic cylinder house the lights, which in this embodiment are LED lights.

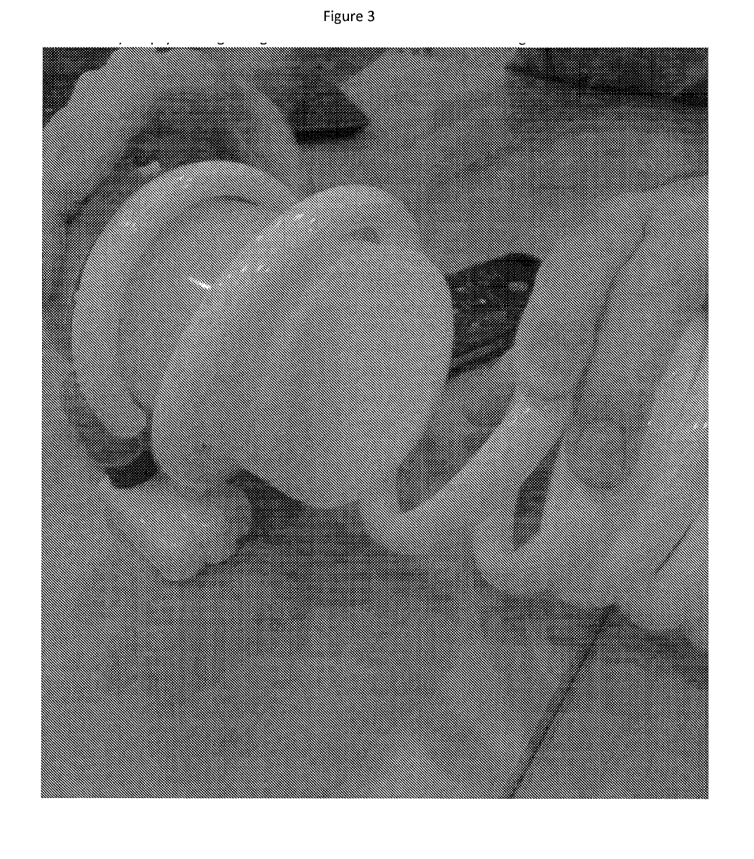

FIG. 4 depicts the cylinder portion of the invention having been placed within coils and the whole structure in movement displaying a lighting effect.

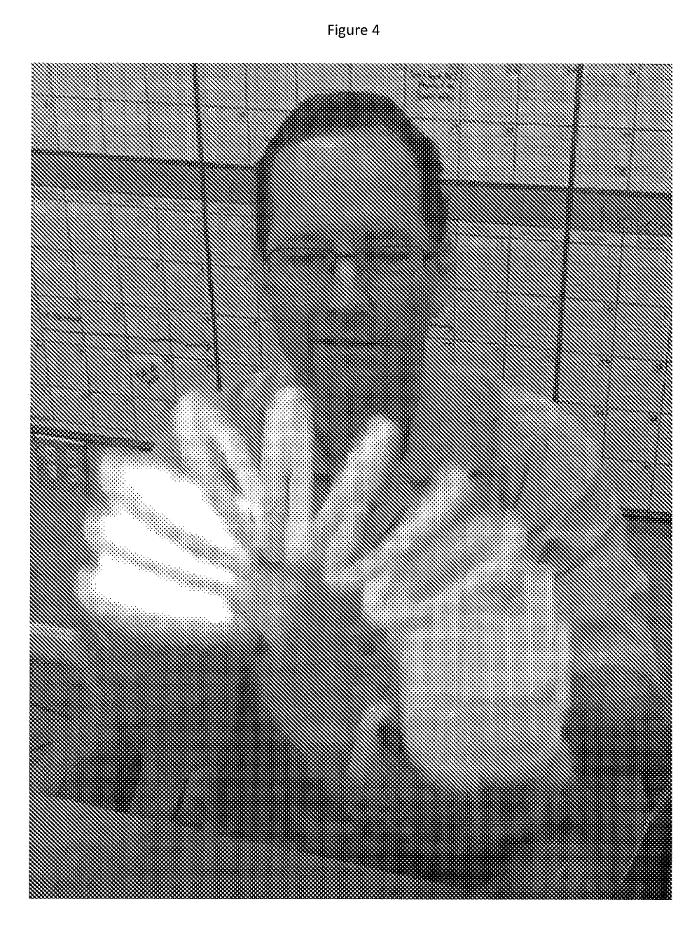

FIG. 5 depicts the cylinder portion of the invention having been placed within coils and the whole structure in movement displaying a different lighting effect.

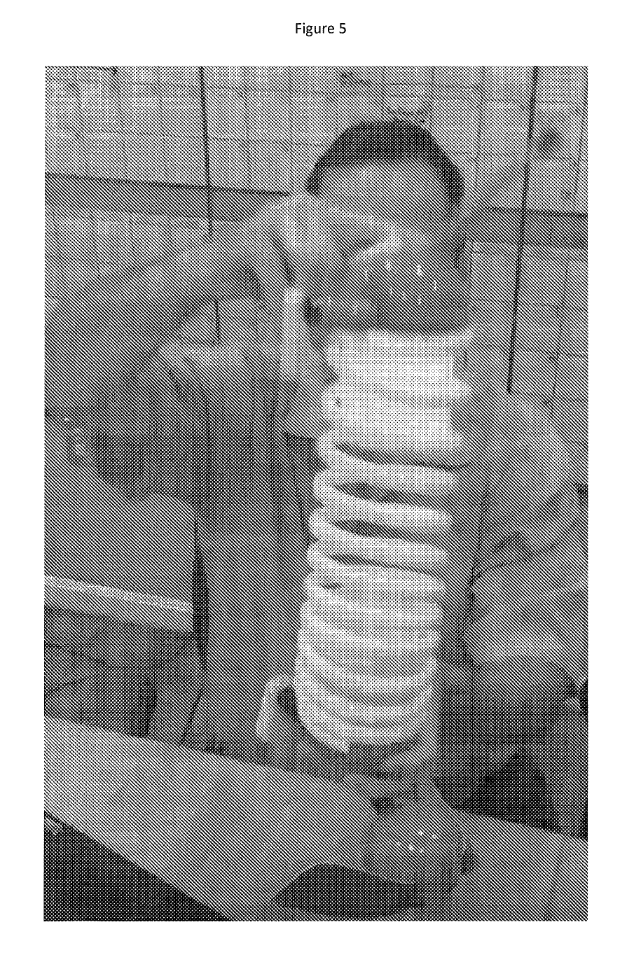

FIG. 6 depicts an embodiment which is shown as a wearable device. The cylinder portion of the invention has been placed within coils and the whole structure in movement displaying a lighting effect created by the invention. In this embodiment two plastic cylinders are placed within the coil, each with its own control unit.

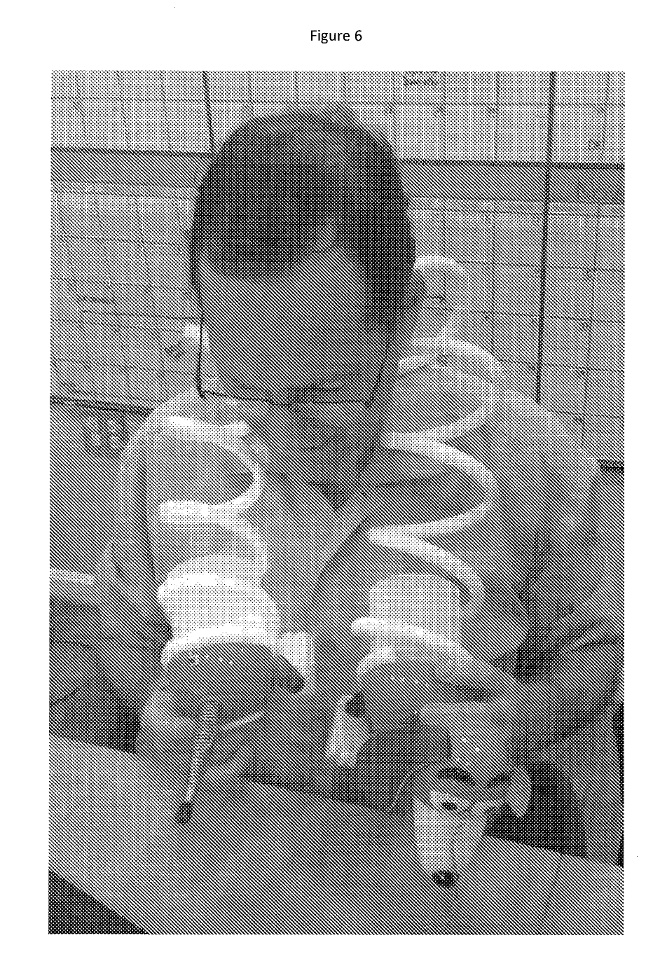

### DETAILED DESCRIPTION OF THE INVENTION

Animated images: an animated image includes layers of plastic capable of transmitting and radiating light as follows:

at least one first layer capable of transmitting and radiating light and at least one first means of edge lighting said at least one first layer and at least one microprocessor and/or electronic controller capable of generating at least one lighting sequence controlling at least one first output that controls said at least one first means of edge lighting to said at least one first layer; or

at least one first layer capable of transmitting and radiating light and at least one second layer capable of transmitting and radiating light;

at least one first means of edge lighting said at least one first layer and at least one second means of edge lighting said at least one second layer and at least one microprocessor and/or electronic controller capable of generating at least one lighting sequence controlling at least one first output that controls said at least one first means of edge lighting to said at least one first layer and at least one second output that controls said at least one second means of edge lighting to said at least one second layer; or

at least one first layer capable of transmitting and radiating light and at least one second layer capable of transmitting and radiating light and at least one third layer capable of transmitting and radiating light and at least one first means of edge lighting said at least one first layer and at least one second means of edge lighting said at least one second layer and at least one third means of edge lighting said at least one third layer and at least one microprocessor and/or electronic controller capable of generating at least one lighting sequence controlling at least one first output that controls said at least one first means of edge lighting to said at least one first layer and at least one second output that controls said at least one second means of edge lighting to said at least one second layer and at least one third output that controls said at least one third means of edge lighting said to at least one third layer.

The said third layer if present has a distance from top or front of the said device greater than distance of said second layer if present which second layer if present is greater than distance of said first layer from the top or front of the said device.

The said at least one first layer is made from at least one transparent and/or translucent material and further comprises at least one first light radiating portion; and said at least one second layer if present is made from at least one transparent and/or translucent material and further comprises at least one second light radiating portion; and said at least one third layer if present is made from at least one transparent and/or translucent material and further comprises at least one third light radiating portion.

The said at least one first light radiating portion and said at least one second light radiating portion if present and said at least one third light radiating portion if present is at least one of an irregular and/or rough surface, etched, sandblasted, molded, engraved, imprinted, ingrained, cut, impressed and/or outlined into said at least one transparent and/or translucent material, an inclusion in said at least one transparent and/or translucent material, at least one refractive element, at least one reflective element, at least one bubble, at least one volume of material that is a different density than said at least one transparent and/or translucent material.

### Switch for Layer of Plastic

At least one first output that controls said at least one first means of edge lighting fades and/or switches off either before and/or during and/or after said at least one second output that controls said at least one second means of edge lighting if present and/or said at least one third output that controls said at least one third means of edge lighting if president fades and/or switches on; and
if present at least one second output that controls said at least one second means of edge lighting fades and/or switches off either before and/or during and/or after said at least one first output that controls said at least one first means of edge lighting and/or said at least one third output that controls said at least one third means of edge lighting fades and/or switches on; and
if present at least one third output that controls said at least one third means of edge lighting fades and/or switches off either before and/or during and/or after said at least one first output that controls said at least one first means of edge lighting and/or said at least one second output that controls said at least one second means of edge lighting fades and/or switches on each plastic layer placed in contact with at least one other plastic layer, with each said plastic layer independently illuminable or illuminated with at least one source of light, each said at least one source of light controllable electronically by at least one controller and/or microprocessor to produce at least one pattern of illumination, with said at least one pattern of illumination initiated by at least one trigger or switch that produces at least one input to said at least one controller and/or microprocessor, having a means to connect as a cup cover or lid and a means for attaching to a surface or person to be wearable.

### Edge Lit Technology

A light source in one location is coupled to a layer of plastic, and the light passes through the material whereupon it strikes a rough surface or a different surface which can cause the transmitted light to scatter in another location, thus producing a visible pattern.

One way the light source is integrated into the invention is by cutting a hole into the plastic so the led fits into the whole by sliding it into the whole and then covering the sides with non-transparent material leaving only the inserted end or side facing the majority of the plastic open for the light to go primarily in one direction facing toward the majority of the plastic a second way which is used in at least one embodiment of the device is to make, by injection molding or other method, hole(s) in a base portion positioned at least one interval from central axis and if more than one layer or shell then the lads are separately positioned at different distances from device top, front, center and/or central axis and then they can be covered as described in process one above. In both cases the use of calibration points which are small dots or lines that are used to make sure the different layers of animation are in the correct spot on the material and to make sure the different layers are lined up with each other correctly is sometimes used.

If one layer is positioned over another layer, and each layer can be independently illuminated, then one pattern can be illuminated, then another can be illuminated, and this can give the appearance that one image is either replacing another, or that one image can blend into another image by fading or dimming one out while fading or dimming the next image up. Alternatively, at least one image or at least one another image and/or both or more images can be displayed.

It can be abruptly switched from one image to the next, or gradually faded, or any combination. The patterns can overlap in time, wherein each is illuminated in some proportion to the maximum brightness, or one image can be completely switched off and the other completely switched on with no overlap in time.

There can also be three, four, five, or more layers, each of which can be independently illuminated, with one image fading and/or switching into the next fading and/or switching into the next and so on, or multiple images can be simultaneously displayed in any combination.

### Edge Lit Technology—Remote Source Light Activation

Each edge lit layer of product can be separately controlled via a third-party control center so images can be turned on or off from the third-party control center in real time and can even be controlled in unison with other units used by others so that a grouping of users all have changing images in unison.

In fact, small group Kitts can be sold for family and other small groups to join in sync which can be controlled by the third-party venue. For example, a themed character a live setting can control the whole families viewing experience.

The image can be at least one of images, text, logos, slogans, characters, other visual materials, and/or other visual content. The product contains at least one communication transmitter/receiver device.

These definitions are in addition to the words and phrases specifically defined in the body of this application.

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and Bin combination; A and C in combination; B and C in combination; or A, B, and C in combination.

A “controlling, executing and/or operating software application” is defined as a program used to control, operate, and/or operate on at least one of the following: a stationary, handheld and/or mobile device, a tablet, smart phone, stationary phone, smart device, computer, hand held device, mobile phone, touch-screen computing device, portable media player, smart pad, smart device, laptop, desktop computer, micro device, portable device, technical device, virtual device, a remote control, a communication transmitter device, a communication transmitter/receiver device, a tracking apparatus, and/or a communication receiver device, among others.

A “remote control” is defined as an electronic device used to wirelessly control another electronic device.

A “stationary, handheld and/or mobile device” is defined as an electronic device that can be at least one of the following: a tablet, smart phone, stationary phone, smart device, computer, hand held device, mobile phone, touch-screen computing device, portable media player, smart pad, smart device, laptop, desktop computer, micro device, portable device, technical device, and/or virtual device.

A “communication receiver device” is defined as any electronic device that can receive signals such as GPS, Wi-Fi, radio wave, Bluetooth, RFID, radio waves, sonar, some, audio, and/or infrared.

A “communication transmitter device” is defined as any electronic device that can transmit signals such as GPS, Wi-Fi, radio wave, Bluetooth, RFID, radio waves, sonar, sonic, audio, and/or infrared.

A “communication transmitter/receiver device” is defined as any electronic device that can transmit and/or receive signals such as GPS, Wi-Fi, radio wave, Bluetooth, RFID, radio waves, sonar, sonic, audio, and infrared.

While the instant invention has been shown and described in accordance with preferred and practical embodiments thereof, it is recognized that departures from the instant disclosure are contemplated within the spirit and scope of the present invention. Therefore, the true scope of the invention should not be limited since other modifications will become apparent to those skilled in the art upon a study of the claims, drawings, descriptions, explanations, and specifications herein. It is understood that various changes and modifications can be made within the spirit and scope of the present invention.

Those skilled in the art will appreciate that the conception, upon which this disclosure is based, may readily be utilized as a basis for the designing of other structures and methods for carrying out several purposes of the present invention. It is therefore important that the claims be regarded as including such equivalent constructions insofar as they do not depart from the spirit and scope of the present invention. As opposed to the claims, the abstract is neither intended to define the invention of the instant application, which is measured by the claims, nor is it intended to be limiting as to the scope of the invention in any way.

1. A lighted coil and/or spring type amusement product comprising:
a clear or opaque plastic container;
a lighting component present within an interior of said container;
a control unit connected to the lighting component, and
a plastic coil and/or spring having a plurality of connected rings defining an interior, a right end, and a left thereof, secured to the container, and at least partially surrounding the container.

2. The invention of claim 1, wherein said lighting components comprise LED lighting.

3. The invention of claim 1, wherein said container is in the form of a cylinder.

4. The invention of claim 1, wherein the control unit is comprised of at least one power source, circuitry, and at least one switch.

5. The invention of claim 4, wherein the control unit further comprises at least one transmitter and/or receiver.

6. The invention of claim 4, wherein the control unit further comprises light sequencing hardware and/or software.

7. The invention of claim 1, further comprising at least one attaching section or device or removably or non-removably attaching directly to an object, person, or surface directly or attached to a necklace, chain, pin, bracelet, or other wearable jewelry or another object, thing, or accessory.

8. The device of claim 1 wherein said at least one microprocessor and/or electronic controller is housed within at least one waterproof or water-resistant compartment and/or imbedded and/or hermetically sealed within at least one portion of said device.

9. The device of claim 1 further comprising at least one lens capable of projecting at least one image on at least one external surface and/or at least one object and/or said at least one first layer and/or at lease one interior surface of said device.

10. The device of claim 1, further comprised of at least one LED and/or source of light and at least one lens capable of projecting at least one image radially outward from and/or beneath said container.

11. A lighted coil and/or spring type amusement product comprising:
a clear or opaque plastic container;
lighting components present within an interior of said container;
a control unit connected to the lighting component, and
a plastic coil and/or spring having a plurality of connected rings defining an interior, a right end, and a left thereof, secured to the container, and at least partially surrounding the container,
wherein LED lights are present within the plastic coil and/or spring.

12. The invention of claim 11, wherein said lighting components comprise LED lighting.

13. The invention of claim 11, wherein said container is in the form of a cylinder.

14. The invention of claim 11, wherein the control unit is comprised of at least one power source, circuitry, and at least one switch.

15. The invention of claim 14, wherein the control unit further comprises at least one transmitter and/or receiver.

16. The invention of claim 14, wherein the control unit further comprises light sequencing hardware and/or software.

17. The invention of claim 11, further comprising at least one attaching section or device or removably or non-removably attaching directly to an object, person, or surface directly or attached to a necklace, chain, pin, bracelet, or other wearable jewelry or another object, thing, or accessory.

18. The device of claim 11 wherein said at least one microprocessor and/or electronic controller is housed within at least one waterproof or water-resistant compartment and/or imbedded and/or hermetically sealed within at least one portion of said device.

19. The device of claim 11 further comprising at least one lens capable of projecting at least one image on at least one external surface and/or at least one object and/or said at least one first layer and/or at least one interior surface of said device.

20. The device of claim 11, further comprised of at least one LED and/or source of light and at least one lens capable of projecting at least one image radially outward from and/or beneath said container.
